(19) United States
(12) Patent Application Publication
(10) Pub. No.: US 2021/0119672 A1
(43) Pub. Date: Apr. 22, 2021

(54) DIGITAL, DISTRIBUTED, WIRE-FREE COMMUNICATION SYSTEM AND CONCENTRATOR

(71) Applicant: Telefonaktiebolaget LM Ericsson (publ), Stockholm (SE)

(72) Inventors: Roland GABRIEL, Kolbermoor (DE); Burkhard MANN, Kolbermoor (DE)

(21) Appl. No.: 17/050,336

(22) PCT Filed: Apr. 16, 2019
(86) PCT No.: PCT/DE2019/100352

§ 371 Date: Dec. 31, 2020

(30) Foreign Application Priority Data
Apr. 26, 2018 (DE) 10 2018 110 156.2

(51) Int. Cl. H04B 7/024; H04B 7/0452; H04B 7/06

(52) U.S. Cl. CPC H04B 7/024; H04B 7/0626; H04B 7/0617; H04B 7/0452

(57) ABSTRACT

The invention relates to a digital, distributed, wire-free communication system having at least two base station antennas arranged adjacent to each other, which are designed as sector antennas having different but adjacent sector illumination, and a concentrator, which communicates with the sector antennas by means of a digital communication signal having antenna-side data streams respectively assigned separately to each sector antenna. The concentrator combines the received antenna-side data streams from the sector antennas into a number of network-side data streams, differing from the number of antenna-side data streams, by using a signal processing matrix operation, wherein at least one of the network-side data streams leaving the concentrator includes parts of at least two antenna-side data streams from at least two adjacent sector antennas. The invention also relates to a concentrator and a method for the joint signal processing of data streams from a plurality of base station antennas arranged adjacent to each other.

The invention relates to a digital, distributed, wire-free communication system and to a concentrator.

Mobile communication networks are known from the prior art. These are equipped with one or more base stations at the respective mobile communication site and transform the signals received from an antenna into the baseband in a multi-stage process. Conversely, the antenna emits signals which are transformed from user data into a high-frequency signal via the corresponding signal processing steps. A plurality of sectors can already be recorded in one base station. Usually, each of these sectors contains its own “cell ID” (LTE: PHY-layer cell ID=3*(cell ID group)+cell ID sector), i.e. it is viewed as a separate cell. A handover is therefore necessary when transitioning from one sector to the next. Even if the handover is simplified, for example by assigning new resources such as a different time slot or different OFDM frequency, a hard handover is avoided and a transition can take place within the framework of resource allocation (RRM—radio resource management), however, these resources cannot be used in both sectors at the same time and the allocation takes place in the higher layers of signal processing. This in turn has runtime disadvantages.

Distributed radio networks are also known, which enable a large number of antenna sites to be jointly processed. Here, the recorded data streams are transmitted in an RF-IQ format, for example CPRI or ORI, to a duster of baseband computers and then jointly processed with regard to linear superposition, i.e. beamforming. From the prior art, however, a maximum of one double MIMO implementation is known for each antenna site for a distributed network—especially for indoor supply networks—see, for example, the K-BOW system from Kathrein Werke KG.

In contrast, the publication “Intra Site COMP in LTE-A Systems: an Antenna-Selected-Based Solution” (Bin-Sung Liao, Wen Rong Wu, and Hung-Tao Hsieh, Department of Electrical Engineering, National Chaio Tung University Hsinchu, Taiwan in 2012 IEEE Wireless Communications and Networking Conference: PHY and Fundamentals, p. 832 ff., DOI: 10.1109/WCNC.2012.6214487) proposes a system of many antennas, which then represents a higher MIMO duster. However, it is also pointed out here that this system has not yet been defined in any standard and that it includes signal processing that is too complex. For example, it is stated that a network MIMO system can be constructed for signal transmission or reception. Precoding in such a system will perform better, but have a high-dimensional codebook which is not supported by current LTE-A systems. (Original: “we can construct a network MIMO system for signal transmission/reception. Precoding in such system will have better performance, however, it requires a high dimension codebook which is not supported by current LTE-A systems”). This article also did not mention how a cost-effective solution, in particular having a realizable runtime requirement, a system for higher MIMO modes and a plurality of antennas can be implemented. Although it is pointed out in this article that only a limited number of antennas should be selected for a MIMO cluster, the selection thereof is derived from theoretical correlation values and no physical implementation is shown.

The publication “Inter-Cluster Design of Wireless Fronthaul and Access Links for the Downlink of C-RAN” (Seok-Hwan Park, Changick Song and Kyoung-Jae Lee, in IEEE WIRELESS COMMUNICATIONS LETTERS, VOL. 6, NO. 2, APRIL 2017, DOI: 10.1109/LWC.2017.2671431) describes a mathematical approach for combining a plurality of antennas; a practical implementation is not shown here. This publication also has the disadvantage that the calculation method becomes very complex, in particular when the cluster becomes very large. Furthermore, in this known approach, all signals are transformed down to the baseband, i.e. the data stream of the end user. Here, too, the “coordinated multipoint transmission” and “coordinated multipoint receiving” processes are not separated from the beamforming simulated there. A physical implementation is not shown. For larger clusters, in particular, no mechanisms for synchronizing the phase position of the distributed sites are shown, such that this source represents a purely mathematical simulation of a hypothetical distribution.

U.S. Pat. No. 9,026,036B2 also describes, for example, a distributed DAS system which docks to a base station and thus does not include its own baseband processing. A transmission via an Ethernet based on intermediate frequency adaptations is presented here.

The disadvantages of the previously known solutions and implementations are, on the one hand, the high demands on extreme data rates as well as synchronicity and latency of the required “fronthaul” connections to the computing clusters for baseband signal processing. Alternatively, the known solutions include the complete baseband processing directly in the respective antenna (small cell approach). This in turn does not permit the use of adjacent antennas for joint MIMO processing.

It is therefore an object of the invention to provide a corresponding communication system and a concentrator, as well as a signal processing method, by means of which transmission at a high data rate with low latency is possible.

According to the invention, this object is achieved by the features of the independent claims. Advantageous embodiments are the subject of the dependent claims.

The invention relates to a digital, distributed, wire-free communication system having at least two base station antennas arranged adjacent to each other, which are designed as sector antennas having different but adjacent sector illumination, and a concentrator, which communicates with the sector antennas by means of a digital communication signal having antenna-side data streams respectively assigned separately to each sector antenna. The concentrator combines the received antenna-side data streams from the sector antennas into a number of network-side data streams, differing from the number of antenna-side data streams, by using a signal processing matrix operation, wherein at least one of the network-side data streams leaving the concentrator includes parts of at least two antenna-side data streams from at least two adjacent sector antennas.

This enables the joint signal processing of signals from a plurality of antennas at one antenna site and, at the same time, sufficient leeway for synchronous signal processing from a plurality of antenna sites that are directly adjacent to each other, e.g. for joint MIMO processing.

In one embodiment, the antenna-side data streams transmitted from the concentrator to the sector antennas are transmitted in a time-synchronized manner such that a phase-synchronous superimposition in the region of the sector illumination and/or a joint MIMO operation of the sector antennas takes place.

In one embodiment, all sector antennas and the concentrator are at a common site, or at least two of the sector antennas are at different sites and the concentrator is either at one of the sites or in a region between the sites, or at least two of the sector antennas are at a common site and further sector antennas are at sites that are directly adjacent to each other, and the concentrator is either at one of the sites or in a region between the sites. Providing the concentrator close to the antenna site reduces latency and enables synchronous transmission.

In one embodiment, the signal processing matrix operation in the concentrator, which is applied to the antenna-side data streams from at least two sector antennas toward the concentrator, maps the antenna-side data streams to a new number of network-side data streams by means of a linear complex matrix operation through a matrix having complex coefficients, and then feeds them to a further matrix operation for phase-synchronous superimposition in the region of the sector illumination and/or MIMO processing.

In one embodiment, the complex matrix operation generates a larger number of network-side data streams than the antenna-side data streams received, by additionally combining parts of two antenna-side data streams from adjacent sector antennas to form a new data stream.

In one embodiment, coefficients of the linear complex matrix operation are modified according to predetermined success criteria and then transferred to the further matrix operation for phase-synchronous superimposition in the region of the sector illumination and/or MIMO processing.

In one embodiment, the coefficients of the complex matrix operation are adjusted for MIMO processing by means of an optimization algorithm as a function of the predetermined success criteria after the further matrix operation.

The processing of the data streams can be optimized in different ways such that the joint MIMO operation is optimized.

Furthermore, a concentrator is provided which is configured for the purpose of the joint signal processing of data streams from a plurality of base station antennas arranged adjacent to each other, which are designed as sector antennas having different but adjacent sector illumination, wherein the concentrator has for this purpose:
transmitting and receiving means for transmitting and/or receiving antenna-side data streams and network-side data streams assigned to individual sector antennas,
signal processing means for processing the data streams in such a way that the received antenna-side data streams from the sector antennas are combined into a number of network-side data streams, differing from the number of antenna-side data streams, by using a signal processing matrix operation, and at least one of the network-side data streams leaving the concentrator includes parts of at least two different antenna-side data streams from at least two adjacent sector antennas.

In one embodiment, the signal processing matrix operation in the concentrator, which is applied to the antenna-side data streams from at least two sector antennas toward the concentrator, maps the antenna-side data streams to a new number of network-side data streams by means of a linear complex matrix operation through a matrix having complex coefficients, and then feeds them to a further matrix operation for MIMO processing. Alternatively, the signal processing matrix operation generates a larger number of network-side data streams than the antenna-side data streams received by means of a linear complex matrix operation through a matrix having complex coefficients, by additionally combining parts of two antenna-side data streams from adjacent sector antennas to form a new data stream.

In one embodiment, coefficients of the linear complex matrix operation are modified according to predetermined success criteria and then transferred to the further matrix operation for phase-synchronous superimposition in the region of the sector illumination and/or MIMO processing. Alternatively, coefficients of the linear complex matrix operation are modified according to predetermined success criteria and then transferred to the further matrix operation for phase-synchronous superimposition in the region of the sector illumination and/or MIMO processing, and the coefficients of the linear complex matrix operation are adjusted by means of an optimization algorithm as a function of the predetermined success criteria after the further matrix operation for phase-synchronous superimposition in the region of the sector illumination and/or MIMO processing.

Furthermore, a method is provided for the joint signal processing of data streams from a plurality of base station antennas arranged adjacent to each other, which are designed as sector antennas having different but adjacent sector illumination. Data streams from at least two sector antennas arranged adjacent to each other are processed by means of a concentrator, such that antenna-side data streams from the sector antennas are combined into a number of network-side data streams, differing from the number of antenna-side data streams, by using a signal processing matrix operation. In this case, at least one of the network-side data streams leaving the concentrator includes parts of at least two antenna-side data streams from at least two adjacent sector antennas. Alternatively, at least one of the network-side data streams leaving the concentrator includes parts of at least two antenna-side data streams from at least two adjacent sector antennas, and the antenna-side data streams transmitted from the concentrator to the sector antennas are transmitted in a time-synchronized manner such that a phase-synchronous superimposition in the region of the sector illumination and/or a joint MIMO operation of the sector antennas takes place.

Further features and advantages of the invention will emerge from the following description of embodiments of the invention, with reference to the drawings which show details according to the invention, and from the claims. The individual features may each be implemented individually or collectively in any desired combination in a variant of the invention. Preferred embodiments of the invention are explained in more detail below with reference to the accompanying drawings.

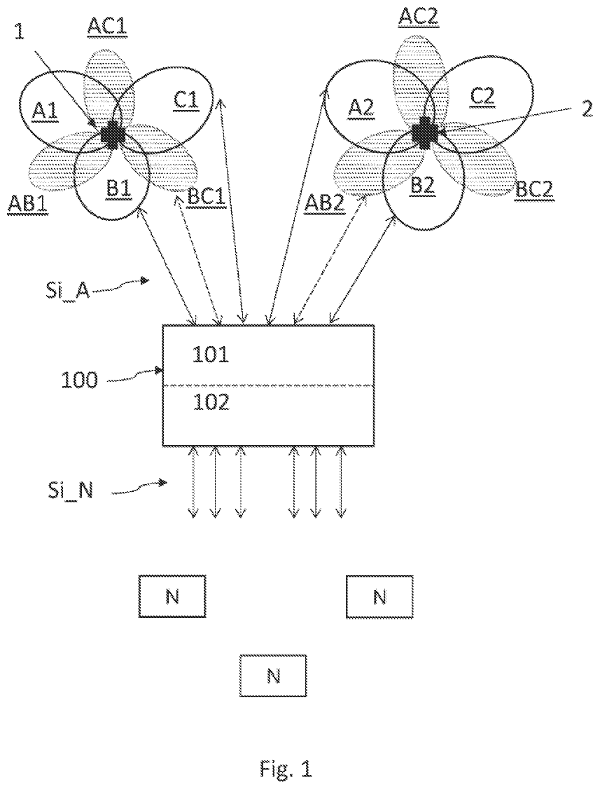

FIG. 1 is a schematic representation of the communication system, the concentrator and the method according to an embodiment of the invention.

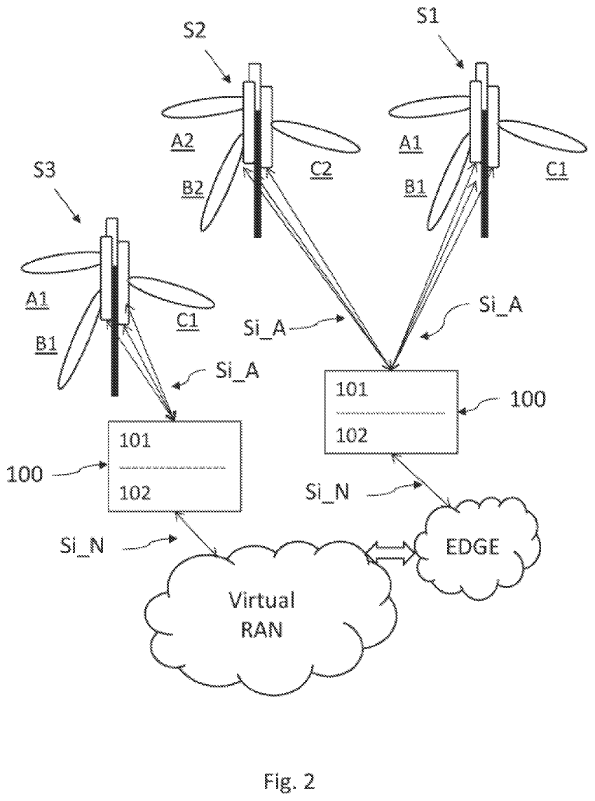

FIG. 2 is a schematic representation of different embodiments of the communication system according to further embodiments of the invention.

The use of adjacent antennas for joint MIMO processing, in particular in a separate unit directly at the antenna site, has not yet been apparent from the prior art.

It is therefore an aim of the invention to provide a suitable communication system, a concentrator 100 as an essential component of the communication system and a signal processing method carried out mainly in the concentrator 100. This is intended to enable both the joint signal processing of signals from a plurality of antennas 1, 2 at one antenna site and, at the same time, sufficient leeway for synchronous signal processing from a plurality of antenna sites that are directly adjacent to each other, e.g. for joint MIMO processing.

The proposed digital, distributed, wire-free communication system as well as the sequence of the method and the concentrator 100 are shown schematically in FIG. 1 (enlarged) and FIG. 2, which each show different embodiments. The communication system has at least two base station antennas 1, 2, which are formed as sector antennas 1, 2.

Sector antennas 1, 2 can be an array of a plurality of antennas or antenna arrays or a plurality of antenna groups in a housing, which are also referred to as antenna systems. An antenna system has a common output or input for the respective RF signals. Dual-polarized antenna systems are considered as two antenna systems. The number of inputs or outputs of a passive antenna is therefore decisive for the number of antenna systems. The number of inputs or outputs is also referred to as a port, i.e. an 8-port antenna includes eight antenna systems. With active antennas, these ports are no longer directly accessible externally; here they are already switched internally in the antenna to a transceiver unit and possibly also digitized. The number of transmitted or received data streams then corresponds to the various antenna systems or ports. The sector antennas 1, 2 can be active or passive antennas or antenna arrays. They can either have a remote radio head RRH directly or the remote radio head RRH can be located at a position adjacent to the associated sector antenna 1, 2 at the site of the antenna. The sector antennas 1, 2 have a specific sector illumination. With MIMO operation, especially “multiuser MIMO”, different propagation paths are used within the sector to separate signals. This then also results in different radiation lobes to the different users in order to ensure multiple uses of the resources. In this respect, the sector is described more generally by the ability of the antenna to generate a corresponding beam, i.e. a radiation lobe, in this region. Subsequently, the regions formed by the radiation diagram of the antennas or antenna arrays are described as illumination sectors A1-C1; A2-C2 of the respective sector antenna 1, 2. This includes both the previously existing, clearly delimited sectors and the multiple uses of resources in a sector from MIMO operation.

The sector antennas 1, 2 can either all be located at a common site or at sites directly adjacent to each other. Advantageously, at least two or three of the sector antennas 1, 2 are at the same site. Further sector antennas 1, 2, which are located at sites directly adjacent to them, can be used for signal processing if required. Adjacent or directly adjacent means that the antenna sites are directly adjacent to each other, e.g. less than 5 km away from each other. The illuminated sectors of the sector antennas 1, 2 should have overlapping regions in order to be able to carry out the proposed signal processing method. The greater the distance, the less likely it is that the illumination sectors of adjacent sector antennas 1, 2 will overlap. In addition, the greater the distance, the longer the latency, making synchronization of the signals difficult or impossible.

As a result of the ongoing virtualization of a wide variety of applications, it is becoming increasingly important, especially in time-critical applications such as mobile communications, to keep latency in the signal propagation time as low as possible. This is achieved by using a signal processing unit formed as a concentrator 100. In this concentrator 100, primarily that part of the signal processing that is time-critical is processed. For this purpose, the concentrator 100 should be as close as possible to the sector antennas 1, 2. This can be achieved by providing the concentrator 100 at the same antenna site as the sector antennas 1, 2. Alternatively, the concentrator 100 can also be provided in a region between two antenna sites if sector antennas 1, 2 from different antenna sites are used for signal processing.

The concentrator 100 has transmitting and receiving means. These can receive data streams from the sector antennas 1, 2 and transmit data streams to the sector antennas 1, 2. Data streams from the concentrator 100 to the sector antennas 1, 2 or from the sector antennas 1, 2 to the concentrator 100 are referred to as antenna-side data streams Si_A. Antenna-side data streams Si_A are data streams from the sector antenna(s) 1, 2, which in some embodiments are present in the form of CPRI-RF-I/Q sampling or an already preprocessed signal, but in each case before so-called layer mapping 102, which is performed in the concentrator 100. The antenna-side data streams Si_A can therefore be CIPRI or I/Q data streams. I/Q (in-phase & quadrature) sampling is understood to be a method for obtaining phase information when demodulating a signal. An interface between radio equipment control and radio equipment is referred to as CPRI (common public radio interface).

The transmitting and receiving means of the concentrator 100 can also transmit or receive data streams from the concentrator 100 to one or more networks N. Data streams from the concentrator 100 to this or these networks N are referred to as network-side data streams Si_N. Such networks can be physically existing networks N, for example one or more users of mobile communication devices, or virtual networks, the so-called virtual cloud.

The concentrator 100 is a signal processing unit in which primarily time-critical processing of signals takes place. Among other things, it is important that the latency of the signal propagation time does not become so great that synchronous processing of two data streams is no longer possible. Layer mapping is one of the most important processes here. With layer mapping, the data streams assigned to the respective users are mapped to the various physical propagation paths within the channel matrix between the user and the base station antenna or, with “multiuser MIMO”, to the various beams, i.e. radiation beams to the various users. For this purpose, the channel matrix and the propagation properties between the user and the base station antenna must be determined. This can take place by feedback on various test signals (closed loop) or by determining the direction from the received signals (open loop). In layer mapping according to the present invention, sector antennas 1, 2, which are physically separate from but adjacent to each other, are now combined with each other by a signal processing matrix operation 102. In this way, parts of two adjacent illumination sectors A1-B1; B1-C1; C1-A1 or A2-B2; B2-C2; C2-A2 can be transferred into a new illumination sector AB1, BC1, AC1 or AB2, BC2, AC2 and used jointly. Optionally, this signal processing matrix operation 102 can be preceded by a further operation, which is advantageously a linear complex matrix operation 101. In this linear complex matrix operation 101, a new vector of virtual and/or real or physical sector antennas 1, 2 is formed by a linear matrix mapping as a superposition of the physical sector antennas 1, 2.

For optimization, an attempt is made to generate as sparse a matrix as possible, such that as little computing power as possible is required in order to select the best possible data stream. This is achieved by predetermining success criteria. These would be, for example, the strongest possible received signal on the network side N. With a sufficiently large volume of data, the coefficients of the complex matrix operation 101 can be adjusted for MIMO processing by means of an optimization algorithm as a function of the predetermined success criteria after the further matrix operation 102. Coefficients represent data streams from individual sectors or illuminated sectors.

The complex matrix operation 101 can generate a larger number of network-side data streams Si_N than the antenna-side data streams Si_A received, by additionally combining parts B1, C1; A2, B2 of two antenna-side data streams Si_A from adjacent sector antennas 1, 2 to a form new data stream BC1; AB2.

In addition to the “MIMO” or “beamforming” processing step, namely phase-synchronous superimposition in the region of the sector illumination, i.e. in the steps in which the concentrator 100 communicates with the sector antennas 1, 2 by means of a digital communication signal having antenna-side data streams Si_A respectively assigned separately to each sector antenna 1, 2, and the layer mapping processing step, in which, as described above, sector antennas 1, 2 which are physically separate from but adjacent to each other are combined with each other by a signal processing matrix operation 102, signal modulation or demodulation can also advantageously take place in the concentrator 100, since a high data rate is required here.

The proposed signal processing in a concentrator 100 of a plurality of sector antennas 1, 2 arranged adjacent to each other enables multiple MIMO processing with low latency.

MU-MIMO (multi-user-multiple-input-multiple-output) applications, which represent a subfield of MIMO applications, can also be implemented. MU-MUMO applications are understood to mean applications in which a plurality of users can communicate with a system that also has a plurality of antennas, for example using a mobile phone having one or more antennas. This means that one sector antenna 1, 2 can supply a plurality of users with different data sets at the same time.

The present invention enables both MIMO applications and beamforming or multiple propagation applications, also referred to as SIMO (single-input-multiple-output) or MISO (multiple-input-single-output), through the use of adjacent antennas at different sites. Thus, the region between two illumination sectors AB1, BC1, CA1; AB2, BC2; CA2 in particular can be supplied with significantly higher data rates of up to 10 Gbit/s or more at the I/Q level, and the signal coverage can be improved. As a result of the proximity of the concentrator 100 to the antenna site, both synchronicity and runtime differences (jitter) of the signals to the various antenna systems or sector antennas 1, 2 are kept in the required range of below approximately 1 microsecond.

If adjacent antenna sites are routed to a common concentrator 100, the sector antennas 1, 2 of separate sites can also cooperate with each other with regard to beamforming and MIMO. As a result, a considerable improvement in the supply is achieved, in particular at the limits of the illumination sectors A1-C1; A2-C2.

Two specific embodiments are shown in FIG. 2. Three sites S1-S3, each with three illumination sectors A1-C1; A2-C2 are shown here. In each illumination sector A1-C1; A2-C2 there is a sector antenna, which is shown in FIG. 2 as a bar arranged vertically on the mast (black bar). An associated narrow radiation lobe is shown for each of the sector antennas, which is located in a partial region of the associated illumination sector A1-C1; A2-C2.

A concentrator 100 is connected to the site on the left with three sector antennas at site S3. In the middle and right-hand sites S1 and S2, there is only one concentrator 100 which is connected to the three sector antennas of the two sites S1, S2. A participant could, for example, be in the overlap region of two illumination sectors A1 and C2 from the two different sites S1, S2. The network N, referred to here as virtual RAN or EDGE, exchanges the data recorded and processed in the concentrator 100. These data are not as time-critical as the data that are processed in the signal processing unit in the concentrator 100.

1-11. (canceled)

12. Digital, distributed, wire-free communication system having the following arrangement:
at least two base station antennas arranged adjacent to each other, which are designed as sector antennas having different but adjacent sector illumination by means of illumination sectors,
a concentrator which communicates with the sector antennas by means of a digital communication signal having antenna-side data streams respectively assigned separately to each sector antenna, and wherein
the concentrator combines the received antenna-side data streams from the sector antennas into a number of network-side data streams, differing from the number of antenna-side data streams, by using a signal processing matrix operation to transfer parts of two adjacent illumination sectors into anew illumination sector and to use them, wherein
at least one of the network-side data streams leaving the concentrator includes parts of at least two antenna-side data streams from at least two adjacent sector antennas.

13. Digital, distributed, wire-free communication system according to claim 12, wherein the antenna-side data streams transmitted from the concentrator to the sector antennas are transmitted in a time-synchronized manner such that a phase-synchronous superimposition in the region of the sector illumination and/or a joint MIMO operation of the sector antennas takes place.

14. Digital, distributed, wire-free communication system according to claim 12, wherein
all sector antennas and the concentrator are at a common site, or
at least two of the sector antennas are at different sites, and the concentrator is either at one of the sites or in a region between the sites, or
at least two of the sector antennas are at a common site and further sector antennas are at sites that are directly adjacent to each other, and the concentrator is either at one of the sites or in a region between the sites.

15. Digital, distributed, wire-free communication system according to claim 12, wherein the signal processing matrix operation in the concentrator, which is applied to the antenna-side data streams from at least two sector antennas toward the concentrator, maps the antenna-side data streams to a new number of network-side data streams by means of a linear complex matrix operation through a matrix having complex coefficients, and then feeds them to a further matrix operation for phase-synchronous superimposition in the region of the sector illumination and/or MIMO processing.

16. Digital, distributed, wire-free communication system according to claim 15, wherein the complex matrix operation generates a larger number of network-side data streams than the antenna-side data streams received, by additionally combining parts of two antenna-side data streams from adjacent sector antennas to form a new data stream.

17. Digital, distributed, wire-free communication system according to claim 15, wherein coefficients of the linear complex matrix operation are modified according to predetermined success criteria and then transferred to the further matrix operation for phase-synchronous superimposition in the region of the sector illumination and/or MIMO processing.

18. Digital, distributed, wire-free communication system according to claim 6, wherein the coefficients of the complex matrix operation are adjusted for MIMO processing by means of an optimization algorithm as a function of the predetermined success criteria after the further matrix operation.

19. Concentrator which is configured for the purpose of the joint signal processing of data streams from a plurality of base station antennas arranged adjacent to each other, which are designed as sector antennas having different but adjacent sector illumination by means of illumination sectors, wherein the concentrator has for this purpose:
transmitting and receiving means for transmitting and/or receiving antenna-side data streams and network-side data streams assigned to individual sector antennas,
signal processing means for processing the data streams in such a way that the received antenna-side data streams from the sector antennas are combined into a number of network-side data streams, differing from the number of antenna-side data streams, by using a signal processing matrix operation to transfer parts of two adjacent illumination sectors into a new illumination sector to use them, and at least one of the network-side data streams leaving the concentrator includes parts of at least two different antenna-side data streams from at least two adjacent sector antennas.

20. Concentrator according to claim 19, wherein the signal processing matrix operation in the concentrator, which is applied to the antenna-side data streams from at least two sector antennas toward the concentrator,
maps the antenna-side data streams to a new number of network-side data streams by means of a linear complex matrix operation through a matrix having complex coefficients, and then feeds them to a further matrix operation for MIMO processing, or
generates a larger number of network-side data streams than the antenna-side data streams received by means of a linear complex matrix operation through a matrix having complex coefficients, by additionally combining parts B of two antenna-side data streams from adjacent sector antennas to form a new data stream.

21. Concentrator according to claim 19, wherein
coefficients of the linear complex matrix operation are modified according to predetermined success criteria and then transferred to the further matrix operation for phase-synchronous superimposition in the region of the sector illumination and/or MIMO processing, or
coefficients of the linear complex matrix operation are modified according to predetermined success criteria and then transferred to the further matrix operation for phase-synchronous superimposition in the region of the sector illumination and/or MIMO processing, and the coefficients of the linear complex matrix operation are adjusted by means of an optimization algorithm as a function the predetermined success criteria after the further matrix operation for phase-synchronous superimposition in the region of the sector illumination and/or MIMO processing.

22. Method for the joint signal processing of data streams from a plurality of base station antennas arranged adjacent to each other, which are designed as sector antennas having different but adjacent sector illumination by means of illumination sectors, wherein data streams from at least two sector antennas arranged adjacent to each other are processed by means of a concentrator, such that antenna-side data streams from the sector antennas are combined into a number of network-side data streams, differing from the number of antenna-side data streams, by using a signal processing matrix operation to transfer parts of two adjacent illumination sectors into a new illumination sector and to use them,
wherein at least one of the network-side data streams leaving the concentrator includes parts of at least two antenna-side data streams from at least two adjacent sector antennas, or
wherein at least one of the network-side data streams leaving the concentrator includes parts of at least two antenna-side data streams from at least two adjacent sector antennas, and the antenna-side data streams transmitted from the concentrator to the sector antennas are transmitted in a time-synchronized manner such that a phase-synchronous superimposition in the region of the sector illumination and/or a joint MIMO operation of the sector antennas takes place.
